(19) United States
(12) Patent Application Publication
(10) Pub. No.: US 2013/0333541 A1
(43) Pub. Date: Dec. 19, 2013

(54) METHOD FOR PRODUCING A SAW BLADE

(71) Applicant: Robert Bosch GmbH, Stuttgart (DE)

(72) Inventors: Urs Karlen, Stalden (CH); Daniel Grolimund, Zuchwil (CH)

(21) Appl. No.: 13/919,805

(22) Filed: Jun. 17, 2013

(30) Foreign Application Priority Data
Jun. 18, 2012 (DE) 10 2012 210 164.0

(51) Int. Cl. B23D 65/00; B23D 61/14

(52) U.S. Cl. CPC B23D 65/00; B23D 61/14
USPC 83/835; 76/112

(57) ABSTRACT

A method for producing a saw blade having saw teeth arranged along a tooth side includes connecting carbide teeth to a tooth support by introducing heat and removing material from the saw blade tip until a distance between the tooth face of the front saw tooth and the saw blade tip does not exceed a limit value.

This application claims priority under 35 U.S.C. §119 to patent application no. DE 10 2012 210 164.0, filed on Jun. 18, 2012 in Germany, the disclosure of which is incorporated herein by reference in its entirety.

### BACKGROUND

The disclosure relates to a method for producing a saw blade having saw teeth which consist of carbide, and also saw blades having saw teeth which consist of carbide.

Saw blades, for example jigsaw blades or reciprocating saw blades having a multiplicity of saw teeth which are arranged along a rectilinear or slightly curved tooth side, are known. The saw teeth consist in each case of a tooth support which may be formed in one piece with the saw blade, and also a carbide tooth which is connected to the tooth support by soldering or welding.

When materials, such as wood for example, are machined, care should be taken to ensure that the saw blades are designed such that it is possible to cut into the material without problems at the beginning of the sawing operation.

### SUMMARY

The disclosure is based on the object of creating a saw blade which is easy to produce and with which it is possible to cut into the material to be machined easily and without problems.

This object is achieved according to the disclosure by way of the features of the disclosure. The dependent claims specify expedient developments.

The method according to the disclosure relates to the production of a saw blade, in particular a rectilinear or at least approximately rectilinear saw blade, having saw teeth arranged along a tooth side between a clamping end of the saw blade and a saw blade tip. The saw blade is fastened in a power tool by way of the clamping end. The saw blade is a jigsaw blade or reciprocating saw blade, and the power tool is preferably a handheld power tool, for example a hacksaw.

The saw teeth on the tooth side extend along a straight line or an only slightly arcuate curve and each consist of a tooth support and a carbide tooth connected to the tooth support. The carbide tooth is connected to the tooth support by introduction of heat, in particular by soldering or welding. The material of the tooth support may differ from that of the carbide tooth. The tooth support may be formed in one piece with the saw blade, with a separate embodiment also being conceivable in principle, for example such that the tooth support is part of a support strip which is intended to be connected to a main body of the saw blade.

In the method according to the disclosure, in a first step, the carbide teeth are connected to the tooth support by the introduction of heat. In a subsequent second step, material is removed from the saw blade tip located at the front by suitable mechanical, if appropriate also thermal, measures until the distance between the saw blade tip and the tooth face of the furthest forward saw tooth does not exceed a predetermined limit value. The limit value is preferably at most 2 mm, for example 1.7 mm.

This procedure for producing the saw blade has various advantages. During the introduction of heat in the first step for connecting the carbide teeth to the tooth support, there is a minimum support volume of the tooth support, it being ensured that no damage to the tooth support occurs by the introduction of heat. Saw blades having a saw blade tip that protrudes axially to a comparatively great extent can be used, said saw blade tip having a sufficient support volume for taking up the heat used during the connection of the frontmost carbide tooth to the tooth support.

This ensures that the tooth support or the saw blade is not damaged by the introduction of heat.

As a result of the subsequent machining of the saw blade tip in the second step and the shortening of the distance of the saw blade tip from the tooth face of the front saw tooth—the tooth face faces away from the saw tooth tip—the cutting-in behavior of the saw blade into the material to be machined is significantly improved. As a result of the comparatively small distance between the tooth face of the furthest forward saw tooth from the blade tip, a comparatively narrow embodiment is achieved, said embodiment improving the penetration of the front saw tooth without significantly impairing the strength.

The removal of material from the saw blade tip in the second step of the production process is preferably carried out in a mechanical manner, for example by stamping or sawing. In this case, it may be expedient to remove the material such that a rectilinear end edge located axially at the front is produced on the saw blade. However, in principle, arcuate end edges are also conceivable.

In the case of a rectilinear end edge, the angle between the end edge and the tooth line which extends through the tooth tips, is advantageously in an angular range of between 60° and 100°. According to a preferred embodiment, the angle is 90°, such that the rectilinear end edge extends perpendicularly to the tooth line.

Both the tooth face and the tooth back of the saw tooth may be finished by grinding, for example in order to produce a desired angular orientation. Thus, it may be expedient for the angle between the tooth face and a perpendicular to the tooth line to be greater than 0°, for example 3°. The angle between the tooth back and the tooth line is for example at least 10° and this angle is preferably smaller than the angle between the end edge and the perpendicular to the tooth line.

The saw teeth may be embodied if appropriate in a set manner, with non-set saw teeth on the saw blade also being possible, if appropriate.

In a further aspect, the disclosure relates to a saw blade, in particular a saw blade for a power tool, having saw teeth arranged along a tooth side, said saw teeth each consisting of a tooth support and a carbide tooth connected to the tooth support and being arranged on the tooth side between a clamping end of the saw blade and the saw blade tip, wherein the production method for the saw blade comprises the above-described method according to the disclosure.

### BRIEF DESCRIPTION OF THE DRAWINGS

Further advantages and expedient embodiments can be gathered from the further claims, the description of the figures and the drawings, in which:

FIG. 1 shows a saw blade for a reciprocating saw, having saw teeth arranged along a rectilinear tooth side,

FIG. 2 shows an enlarged illustration of the end-side region of the saw blade,

FIG. 3 shows a further embodiment of the end-side region of a saw blade,

FIG. 4 shows yet another embodiment of the end-side region of a saw blade,

FIG. 5 shows a view from below of a saw blade having non-set saw teeth,

FIG. 6 shows a view from below of a saw blade having set saw teeth.

In the figures, identical components are provided with identical reference signs.

### DETAILED DESCRIPTION

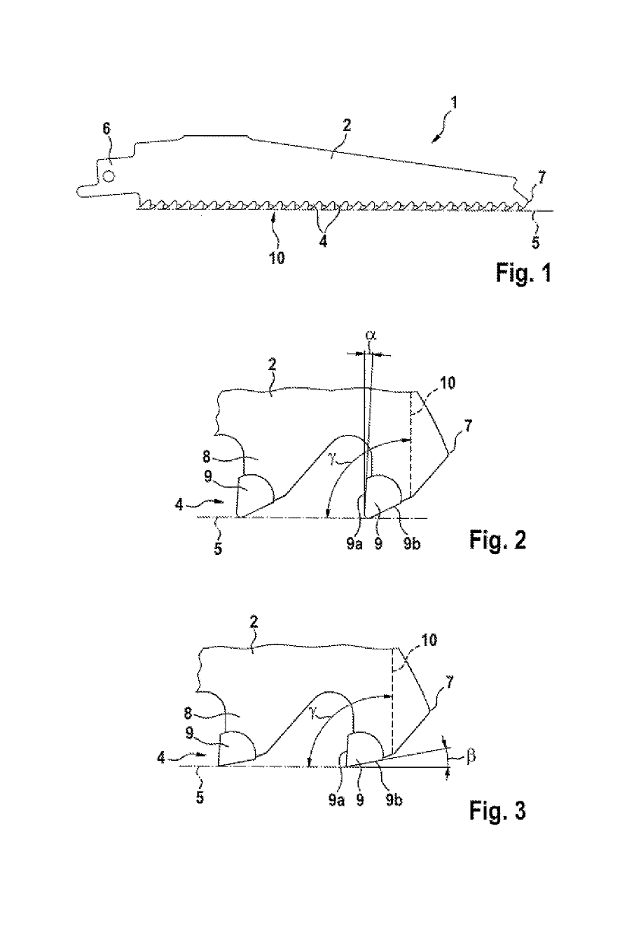

FIG. 1 illustrates a saw blade 1 for a hacksaw configured as a reciprocating saw. The saw blade 1 has a blade support 2 having a multiplicity of saw teeth 4 which are arranged along a tooth side 3 on the blade support 2. The tooth line 5 through the tips of the saw teeth 4 is configured in a rectilinear manner, with a slightly arcuate tooth line also being conceivable. Axially, the saw teeth 4 extend between a rear clamping end 6, via which the saw blade is clamped in the power tool, and the front saw blade tip 7.

As can be seen from FIGS. 2 to 4, each saw tooth 4 consists of a tooth support 8 and a carbide tooth 9 connected to the tooth support 8. The tooth support 8 is preferably embodied in one piece with the blade support 2 and forms the main portion of the saw tooth 4, the tip of which is formed by the carbide tooth 9. The carbide tooth 9 is connected to the tooth support 8 by introduction of heat, in particular by soldering or welding. The blade support 2 and the tooth support 8 preferably consist of a different material from the carbide tooth 9.

The production process for producing the saw blade 1 comprises two temporally successive production steps which are carried out on the basis of the already existing blade support 2 including tooth supports 8. These production steps comprise, in the first step, the attachment of the carbide teeth 9 to the respectively associated tooth support 8 by means of introduction of heat and, in a subsequent second step, the removal of material from the original saw blade tip 7 down to a rectilinear end edge 10 which is illustrated by a dashed line in FIGS. 2 and 3.

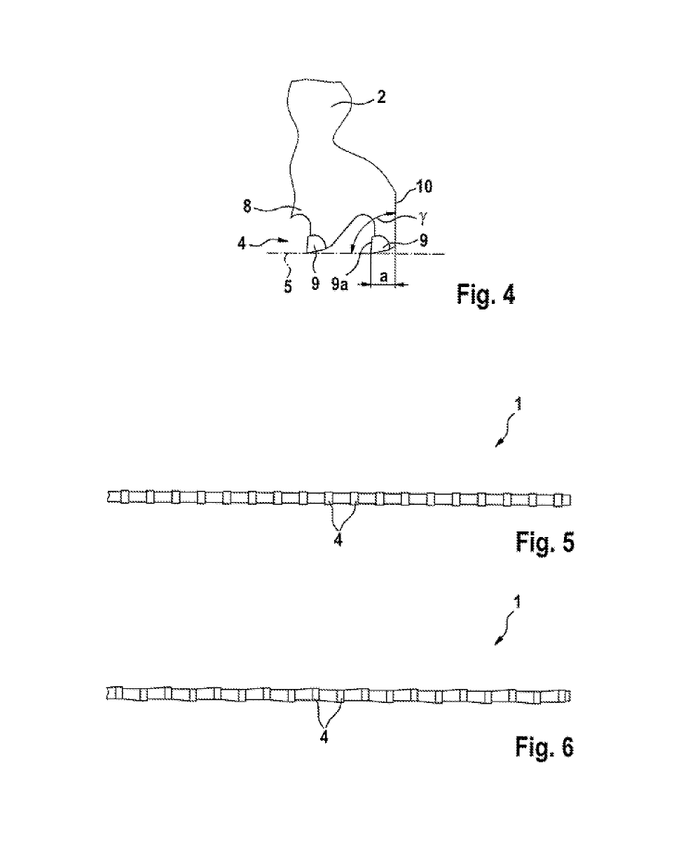

This procedure has the advantage that, during the introduction of heat for connecting the carbide teeth 9 to the tooth support 8, in the end-side region of the saw blade a larger support volume is available in the region of the front region, immediately adjacent to the saw blade tip, to take up heat. Once the carbide teeth 9 have been connected to the tooth support 8, material can be removed from the saw blade tip 7 in order to reduce the distance a (FIG. 4) between the tooth face 9a of the front saw tooth 9 and the end edge 10 to a defined amount. The tooth face 9a in this case faces away from the saw blade tip or the end edge 10. On account of the small axial extent a in the region of the frontmost saw tooth 4, it is easier for the tip of the saw blade to cut into the material at the beginning of the machining of the workpiece. This allows, for example, better machining of wood.

The saw blade tip is, as illustrated by way of the dot-dashed line 10 in FIGS. 2 and 3 and by the solid line in FIG. 4, embodied as a rectilinear end edge. The angle γ between the end edge 10 and the tooth line 5 is preferably in an angular range of between 60° and 100°, in particular 90°.

The tooth face 9a can take up an angle α, with respect to a perpendicular to the tooth line 5, which is greater than 0°, but smaller than 15° and is for example 3°, such that the tooth face 9a is inclined slightly in the direction of the front end edge 10. The tooth back 9b can, as can be gathered from FIG. 3, take up an angle β, with respect to the tooth line 5, of for example 10°, with the angle β opening in the direction of the front end edge 10 and the tooth back 9b being located above the tooth line 5.

According to FIG. 5, the saw teeth 4 on the tooth side are oriented in a rectilinear manner and are not set. According to FIG. 6, by contrast, the saw teeth 4 are set.

What is claimed is:

1. A method for producing a saw blade having saw teeth arranged along a tooth side, said saw teeth each including a tooth support and a carbide tooth connected to the tooth support and being arranged on the tooth side between a clamping end of the saw blade and a saw blade tip, the method comprising:
connecting the carbide teeth to the tooth support by introducing heat; and
removing material from the saw blade tip until a distance between a tooth face of the front saw tooth and the saw blade tip does not exceed a predetermined limit value, the tooth face of the front saw tooth facing away from the saw blade tip.

2. The method according to claim 1, wherein the distance is at most 2 mm.

3. The method according to claim 1, wherein the material is removed from the saw blade tip in such a way that a rectilinear end edge is formed on the saw blade following the removal of the material.

4. The method according to claim 3, wherein an angle between the rectilinear end edge on the saw blade and a tooth line through the tooth tips is in an angular range of between 60° and 100°.

5. The method according to claim 4, wherein the angle is 90°.

6. The method according to claim 3, wherein an angle between a tooth back and a tooth line through the tooth tips is smaller than the angle between the end edge and the perpendicular to the tooth line.

7. The method according to claim 1, wherein the saw teeth are machined in such a way that an angle between a tooth back and a tooth line through the tooth tips is at least 10°.

8. The method according to claim 1, wherein the saw teeth are machined in such a way that an angle between the tooth face and a perpendicular to a tooth line through the tooth tips is greater than 0°.

9. The method according to claim 1, wherein the saw teeth are set.

10. The method according to claim 1, wherein the saw teeth are ground.

11. A saw blade, comprising:
saw teeth arranged along a tooth side, said saw teeth each including a tooth support and a carbide tooth connected to the tooth support and being arranged on the tooth side between a clamping end of the saw blade and a saw blade tip,
wherein the saw blade is produced by:
connecting the carbide teeth to the tooth support by introducing heat; and
removing material from the saw blade tip until a distance between a tooth face of the front saw tooth and the saw blade tip does not exceed a predetermined limit value, the tooth face of the front saw tooth facing away from the saw blade tip.

12. The method according to claim 2, wherein the distance is 1.7 mm.

13. The saw blade according to claim 11, wherein the saw blade is for a power tool.
